(19) United States
(12) Patent Application Publication
(10) Pub. No.: US 2003/0071743 A1
(43) Pub. Date: Apr. 17, 2003

(54) Aircraft monitoring and incident management system

(75) Inventors: Moon-Ming Seah, Singapore (SG); Chong-Khim Ng, Singapore (SG); Yue-Pui Cheong, Singapore (SG); Thiam-Beng Lau, Singapore (SG); Tau-Fuie Lim, Singapore (SG); Gim Pew Quek, Singapore (SG); Richard Hunter, Singapore (SG); Chong-Jin Lim, Singapore (SG); Yui Kwan, Singapore (SG); Siew-Lang Lim, Singapore (SG); Fook-Sun Lee, Singapore (SG); Tik-Bin Oon, Singapore (SG); Chee-We Ng, Singapore (SG); Eng Huat Tay, Singapore (SG); Chee Chung Chong, Singapore (SG); Yew Liam Ng, Singapore (SG)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Singapore Technologies Electronics Limited, Singapore (SG)

(21) Appl. No.: 10/267,432

(22) Filed: Oct. 9, 2002

Related U.S. Application Data
(60) Provisional application No. 60/329,142, filed on Oct. 12, 2001.
(60) Provisional application No. 60/340,337, filed on Dec. 12, 2001.

(51) Int. Cl. G08B 21/00

(52) U.S. Cl. 340/945; 340/574; 340/573.1; 340/540

(57) ABSTRACT

The invention comprises a monitoring and incident management system for an aircraft including an on-board system on the aircraft, an incident management center on the ground, and a redundant secure communications link between the on-board system and the incident management center. The on-board system includes components that assist the aircraft crew in identifying and defending against potential threats to the aircraft, such as suspicious passenger activity. The incident management has access to a wide variety of information concerning the aircraft and activities taking place on the aircraft, as well as the ability to transmit commands to the on-board system. The on-board system includes a cockpit door module that combines double-doors and biometric identification to prevent unauthorized access to the cockpit.

### CROSS REFERENCE TO RELATED APPLICATIONS

This application claims the benefit of U.S. Provisional Patent Application No. 60/329,142, filed Oct. 12, 2001, and U.S. Provisional Patent Application No. 60/340,337, filed Dec. 12, 2001, which are hereby incorporated by reference as if fully set forth.

### FIELD OF INVENTION

This invention relates generally to aircraft and in-flight security. In particular, this invention relates to a monitoring and incident management system to deter threats such as hijacking, to respond to the threat or incident when it happens, and to provide crucial information to an investigation following the threat or incident.

### BACKGROUND

Existing aircraft security practices focus on the following:

(1) gathering intelligence about possible further incidents, such as hijacking;

(2) in-airport security measures designed to prevent weapons, explosives or other items that could potentially be used to damage an aircraft or pose a threat to those on-board the from getting on-board the aircraft, and

(3) post-incident investigation using the cockpit voice recorder (CVR) and the flight data recorder (FDR), commonly known as the “black-boxes.”

Feher, U.S. Pat. No. 4,816,829, discloses a system to augment traditional black box systems with a third black box that records image data from video cameras positioned about the exterior and interior of the aircraft. Feher also discloses a telemetry device to transmit the image data to a ground recording station.

Fujimoto, U.S. Pat. No. 5,283,643, discloses a video camera in the cockpit and a video camera facing the nose of the fuselage and a video recorder on-board were proposed.

Bellman et al., U.S. Pat. No. 4,839,439, discloses an aircraft surveillance system including audio and video sensors located in the interior of the plane and a transmitter to transmit signals from the sensors to a ground recording station.

Lee, U.S. Pat. No. 5,742,336, discloses an aircraft surveillance and recording system including video cameras located on an aircraft, a satellite to relay analog composite video and audio signals from the cameras to a ground station, and video monitors capable of displaying multiple video images located in the ground station.

One of the deficiencies of existing aircraft security practices is that they do not provide reliable means to quickly identify incidents, such as a hijacking, as they occur and to provide decision-makers on the ground with the information necessary to react appropriately to the incident. These and other deficiencies of existing security practices were evident during the events of Sep. 11, 2001 in New York, Washington and Pennsylvania

### SUMMARY

The present invention comprises a monitoring and incident management system for an aircraft. The system includes a plurality of sensors located on the aircraft that monitor critical aircraft information and activity on the aircraft. The system further comprises at least one panic button located on the aircraft that can be activated by a person located in the cabin and at least one computer located on the aircraft that receives and stores input from the plurality of sensors. The system also includes an incident management center located remotely from the aircraft and a two-way communication link between the computer and the incident management center. The two-way communication link is operationally configured to transmit data from the computer to the incident management center and to transmit commands from the incident management center to the computer.

In another respect, the invention comprises a security system for an aircraft cockpit including a cockpit door module having a frame, a front door and a rear door. The front door is operationally configured to open only when the rear door is closed.

In yet another respect, the invention comprise a monitoring and incident management system for an aircraft. An incident management center located remotely from the aircraft. An on-board system including a computer in communication with a cockpit and flight security subsystem, a surveillance and sensor subsystem, and countermeasures. A two-way communication link between the computer and the incident management center. The two-way communication link is operationally configured to transmit data from the computer to the incident management center and to transmit commands from the incident management center to the computer to control the flight security subsystem, the surveillance and sensor subsystem, and/or the countermeasures.

### BRIEF DESCRIPTION OF THE DRAWINGS

The following detailed description of the preferred embodiments of the invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a schematic drawing of the monitoring and incident management system of the present invention.

FIG. 2 is a block diagram illustrating the functional design of the portions of the system located on-board the aircraft.

FIG. 3 is a perspective view, from front and above, of the cockpit door module.

FIG. 4 is an enlarged sectional view taken along line 4-4 of FIG. 3.

FIG. 5 is an enlarged sectional view taken along line 5-5 of FIG. 3.

FIG. 6 is an enlarged sectional view taken along line 6-6 of FIG. 5.

FIG. 7 is an enlarged sectional view of a alternate embodiment of the tie-down shown in FIGS. 5 and 6.

FIG. 8 is an enlarged partial view of the area shown in broken lines in FIG. 3.

FIG. 9 is a sectional view taken along line 9-9 of FIG. 8.

FIG. 10 an overhead view of a cockpit area that has been modified to include the double-door module of the present invention.

FIG. 11 is a block diagram illustrating the functional design of a preferred embodiment of the surveillance and sensor subsystem.

FIG. 12 is a block diagram illustrating the functional design of an alternate preferred embodiment of the surveillance and sensor subsystem.

FIG. 13 is a block diagram illustrating the functional design of a preferred embodiment of the countermeasure subsystem.

FIG. 14 is a block diagram illustrating the functional design of a preferred embodiment of the on-board computer.

FIG. 15 is a flow chart showing the operational flow of a preferred embodiment of the aircraft monitoring and incident management system.

### DETAILED DESCRIPTION OF THE PREFERRED EMBODIMENT(S)

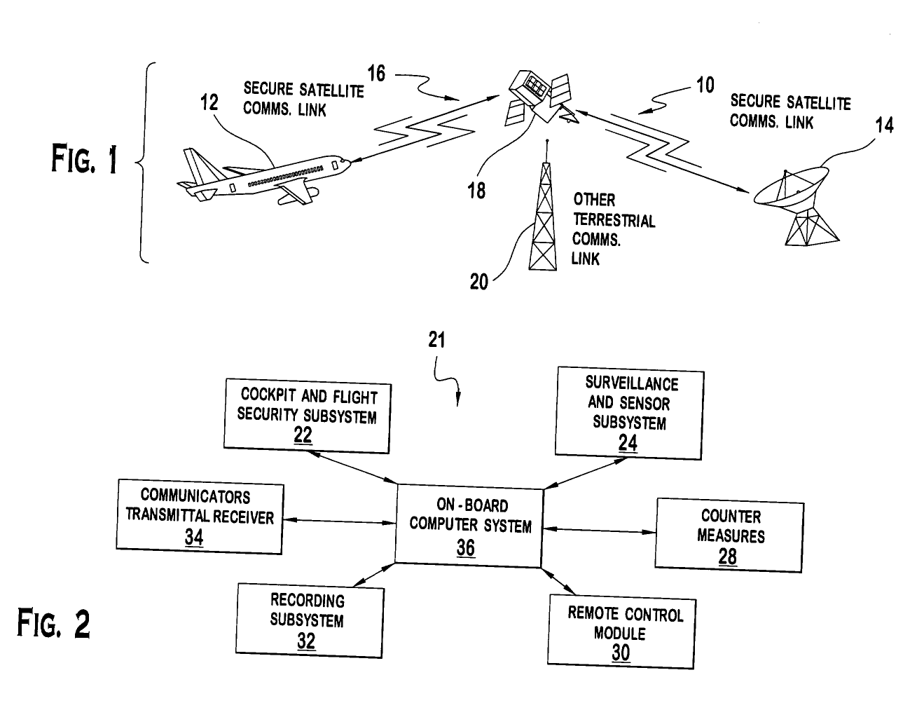

Referring now to FIGS. 1-2, the present invention comprises an aircraft monitoring and incident management system 10. The system 10 preferably includes an on-board system 21 located on an aircraft 12 that are linked via a secure communications link 16 to a ground monitoring and incident management center 14.

The on-board system 21 preferably includes the following subsystems:

(1) a cockpit and flight security subsystem 22;

(2) a surveillance and sensor subsystem 24;

(3) countermeasures 28;

(4) a remote control module 30;

(5) a crash-proof recording subsystem 32; and

(6) a communications transceiver 34.

These elements are all controlled on-board the aircraft 12 by an on-board computer system 36. Although the preferred on-board system 21 includes all of the above subsystems, any subset of the subsystems can be used without departing from the present invention.

The ground center 14 includes a communications transceiver linked to a monitoring and incident management computer system. Optionally, the ground center 14 can be configured to allow remote access to the monitoring and incident management computer system by off-site decision makers over a secure network. The capabilities of the ground center 14 will be best understood after a complete description of the on-board system 21, and therefore, will be described in greater detail herein.

The cockpit and flight security subsystem 22 preferably includes:

a. a double door module 44 for the cockpit with a compartment between the two doors where only one of these doors can be unlocked and open at any one time;

b. a biometrics subsystem, such as facial or fingerprint recognition, for example, to prevent an unauthorized person from controlling the aircraft; and

c. an enhanced auto pilot module, including access control, that can prevent unauthorized deviation of the aircraft from its predetermined flight path, redirect the plane to a less populated region, put the aircraft in circling flight at a controlled altitude, or other pre-determined flight pattern.

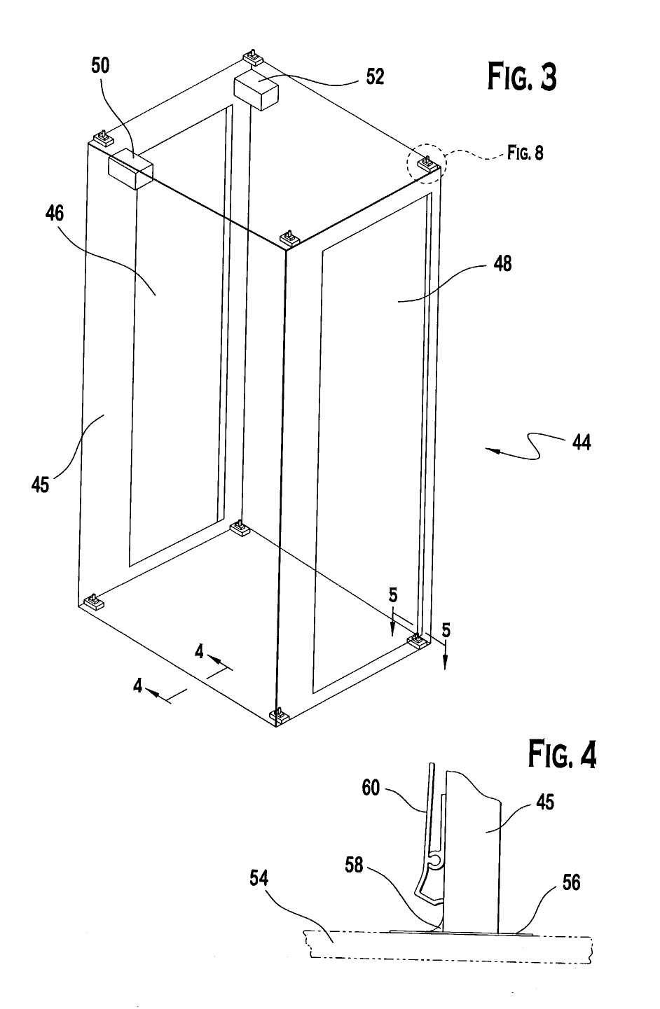

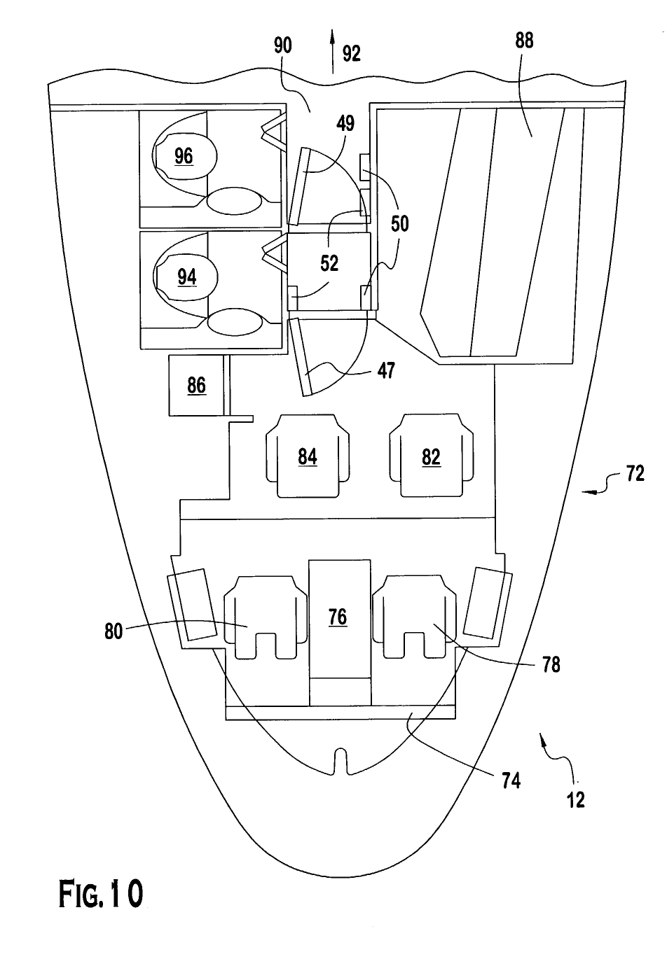

FIG. 3 shows a preferred embodiment of the double door module 44, which is located just to the rear of the cockpit of the aircraft 12. The module 44 comprises a frame 45 having front and rear door openings 46, 48 that support front and rear doors 47, 49 (see FIG. 10). A monitoring device 50, such as a video camera and/or microphone is preferably located within the frame 45 to enable crew members (and even persons at the ground center 14) to observe anyone entering the module 44. An identification and authentication device 52, such as a fingerprint or retinal scanner, for example, is also preferably provided and in communication with the on-board computer 36. The front door is preferably configured to deny entry to the cockpit to any person not authorized to be in the cockpit, as determined by the identification and authentication device 52.

It is also preferable that the module 44 be sealed when the front and rear doors 46, 48 are closed. This enables the use of gas to sedate or otherwise incapacitate a person (or persons) standing in the module 44 who posed a potential threat to the aircraft 12, such as an authorized person trying to gain access to the cockpit. FIG. 4 shows an example of a means for sealing the frame 45 along the floor 54 of the aircraft 12. In FIG. 4, the frame 45 rests atop a sheet 56 of polyester film, such as Mylar® film produced by E. I. du Pont de Nemours and Company, for example, and is further sealed with a bead 58 of a sealant. A kickplate 60 may also be provided.

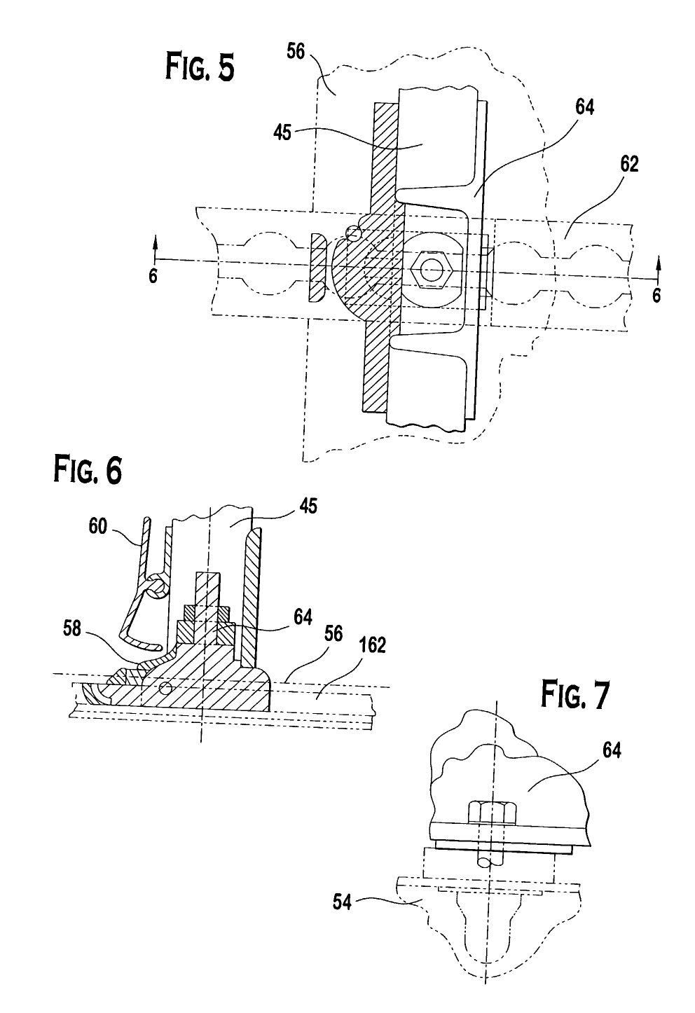

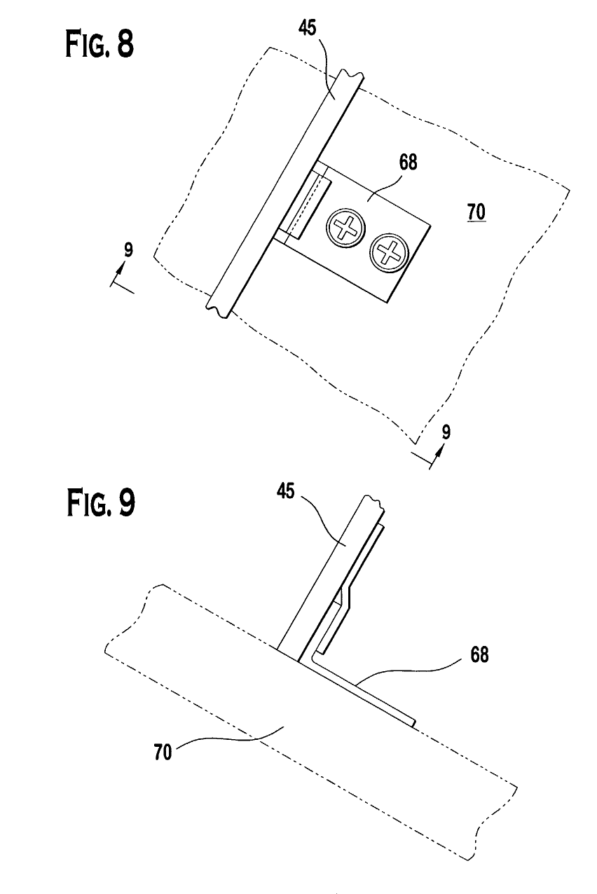

The double door module 44 can be secured to the aircraft 12 by any convenient means. FIGS. 5-7 show two examples of means for securing the module 44 to the floor 54 of the aircraft 12. For example, FIGS. 5-6 show a tie-down 64 secured to a seat-track 62. FIG. 7 shows a tie-down 66 which is secured directly to the floor 54 (i.e., no seat track is used). FIGS. 8-9 show two views of a bracket 68 used to secure the module frame 45 to the ceiling 70 of the aircraft 12. Flexibility in the installation of the double door module 44 is important so that the module 44 can be easily retrofitted into existing aircraft.

FIG. 10 shows an example of a cockpit 72 for the aircraft 12 that incorporates the double door module 44. The cockpit 72 is based on the layout of a Boeing 747-400 and is intended to be merely exemplary. Obviously, the incorporation of the on-board system 21 of the present invention could vary widely.

Beginning at the front of the cockpit 72, the main instrument panel 74 is located in front of the captain's seat 78 and a control stand 76 is positioned between the captain's seat 78 and the first officer's seat 80. Two observer's seats 82, 84 are located immediately to the rear of the captain's seat 78 and the first officer's seat 80, respectively. A coat stowage area 86 and crew rest area 88 are located at the rearmost portion of cockpit 72. The double-door module 44 is preferably located in a hallway 90 linking the cockpit 72 to the passenger cabin 92. As described with respect to FIG. 4, the module 44 includes monitoring devices 50 and identification and authentication devices 52. The front door 47 preferably opens into the cockpit 72 and the rear door 49 opens towards the passenger cabin 92. Two lavatories 94,96 are also preferably provided. The lavatory 96 closest to the passenger cabin 92 is for use by passengers. The forward-most lavatory 94 is for use by the cockpit 72 crew and is positioned between the front and rear doors 47,49 of the module 44 to enable the crew to use this lavatory 94 without opening the rear door 49.

The biometrics subsystem is preferably integrated into the double-door module 44, the autopilot subsystem and other parts of the airplane 12 to determine whether a person trying to gain access to part of the airplane 12 or critical systems, such as the autopilot module or the communications systems, is authorized. The biometrics subsystem preferably -includes facial recognition devices, fingerprint identification devices, retinal scanners, and the like.

The enhanced autopilot module comprises access control and enhanced features to deal with emergency situations and incidents. The access control preferably includes password protection and/or biometric identification. Access control is engaged when the alert mode (described in detail below) is activated. When engaged, the auto pilot can only be disengaged with the password, the positive biometric identification, with an override command from the ground station 14 or at a predetermined time period, point in the flight path, altitude or rate-of-descent. The predetermined time period is preferably variable, depending on the length of the flight. The access control password is preferably changed from flight to flight, depending on the operational flight procedure of the airline.

The surveillance and sensor subsystem 24 comprises a variety of devices to detect potential threats to the safety of the aircraft 12 and to enable the crew and ground center 14 to monitor the activities both inside and outside the aircraft 12. These devices are preferably controllable by the on-board computer 36 via can have either wired or wireless connections. The surveillance and sensor subsystem 24 preferably includes one or more visible or hidden digital video cameras, infrared video cameras, microphones and the like in the cockpit, cabin and other areas of the aircraft. The surveillance and sensor subsystem 24 also preferably includes one or more “panic buttons”, door sensors and tamper sensors, all of which are designed to alert the crew and the ground center 14 that an incident is potentially in progress.

The panic buttons are manually activated by the crew. Each “panic button” is preferably located at a location so that the cabin crew or the pilot can activate it discretely. In order to reduce the likelihood of a false alarm, the panic buttons are preferably not accessible by passengers. The panic buttons are also preferably installed in manner so as to discourage attempts to disable them.

The door sensors notify the crew and ground center 14 if persons entered unauthorized portions of the aircraft 12. The tamper sensors notify the crew and ground center to tampering with monitored portions of the aircraft systems. In order to prevent a hijacker from disabling sensors, “dummy” sensors are preferably provided to make it difficult for hijackers to locate and destroy the genuine sensors. The surveillance and sensor subsystem 24 also preferably includes a global positioning system (GPS) to allow the ground center 14 to monitor the position of the aircraft 12 at all times.

Each tamper sensor is, by definition, designed to alert the on-board computer 36 when a portion of the on-board system 21 has been tampered with, i.e., destroyed, cables cut, etc. Any type of conventional tamper sensor will be suitable. The exact type of tamper sensor is preferably kept secret for security reasons. One simple way of implementing a tamper detector/sensor for each sensor, is to make the sensor periodically poll the on-board computer 36.

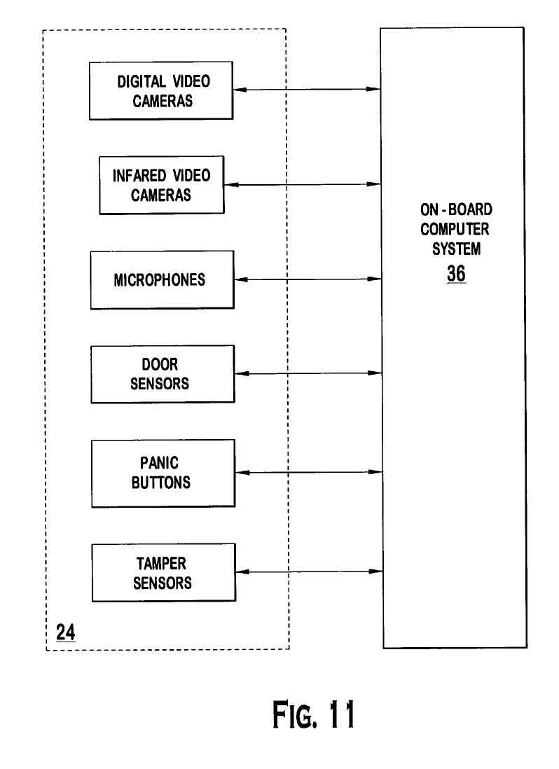

FIG. 11 illustrates the functional relationship between the various components of a preferred embodiment of the surveillance and sensor subsystem 24 and the on-board computer 36. As shown in FIG. 11, each component of the surveillance and sensor subsystem 24 is preferably in two-way communication with the on-board computer 36.

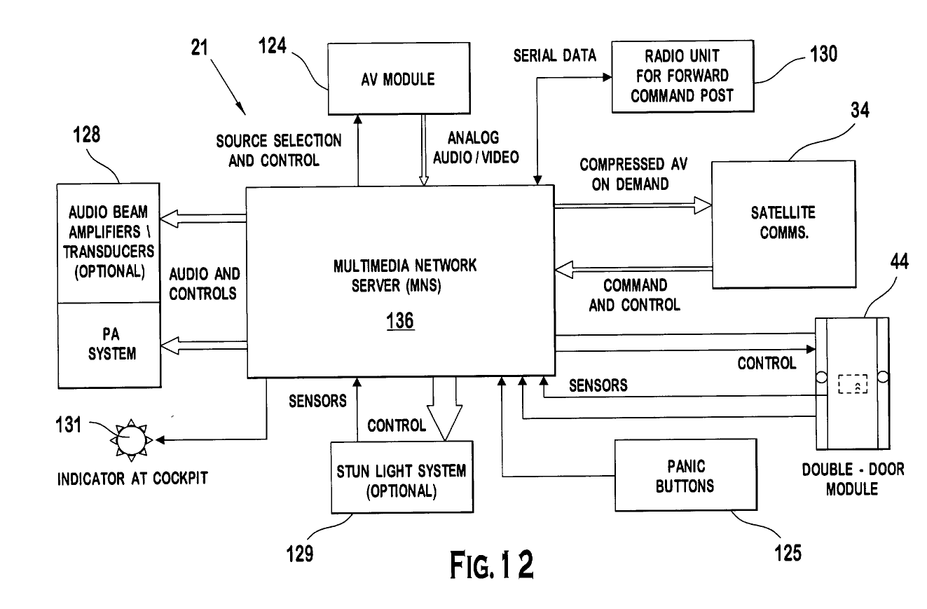

FIG. 12 shows a functional layout of another preferred embodiment of the on-board system 21. The surveillance and sensor subsystem 24 consists of an AV module 124 and panic buttons 125. The on-board computer system 36 comprises a multimedia network server 136. The counter-measure subsystem 28 comprises a audio beam 128 and a stun light 129. The AV module 124 allows the multimedia network server 136 to control camera and audio systems, including adjusting the zoom, focus and other controls. The multimedia network server 136 can also select the sources that will be processed. Compressed audio/video can be transmitted on demand to the ground station via satellite communication subsystem 34. Part of the sensor system is also the panic buttons 125 as well as tamper sensors on the double-door module subsystem 44, which informs the ground center 14 of an incident, through satellite communication system 34 via the multimedia network server 136. If so desired by the persons located in the ground center 14 or the pilot, the counter-measure subsystem 28 (audio-beam 128 and stun light 129) can be activated against threats in the airplane 12. The radio unit 130 is used for situations when the aircraft 12 has landed safely. Ground troops waiting at a forward command post (not shown) can have access to audio/visual data captured by the AV module 124 before storming the aircraft 12.

After a threat to the aircraft 12 is discovered, countermeasures 28 are preferably available to attempt to neutralize the threat. The countermeasures 28 can be controlled by either the pilot or remotely controlled from the ground center 14 to:

a. emit highly directional audio at a selected location in the aircraft 12;

b. emit directed or non-directed blinding flashes at a selected location in the aircraft 12;

c. emit directional audio, flash stunning light, or other non-lethal measures at any unauthorized persons at the pilot seat;

d. release sleeping gas or other similar gas;

e. decompress the cabin;

f. separate, by means of remote-activated doors, different sections of the aircraft; and

g. control the cabin lighting system and the cabin window panels to put the cabin in total darkness.

These countermeasures 28 preferably can be activated by the pilot, or by the ground station either individually or in combination.

The directional audio can be implemented using existing or developing technologies. Suitable directional audio includes, for example, a system developed at the Massachusetts Institute of Technology (MIT) the uses the non-linearity of air to convert a narrow beam of ultrasound into a highly directive, audible beam of sound, the Audiobeam directional loudspeaker by Sennheiser Electronic GmbH & Co. KG and Directed Stick Technology or HyperSonic Sound Technology by American Technology Corporation. The stunning or blinding flashes can be easily implemented with readily available technology.

Directional audio and the stunning or blinding flashes are a non-lethal method to disable and confuse the hijackers momentarily, so that passengers or crew can overpower them. The directional audio and the stunning flashes also serve to disrupt communications between the hijackers and isolate them in different compartments. Isolating the hijackers in different compartments will enable the passengers and crew to disable them more easily.

Decompressing the cabin forces the hijackers to move to a position in the cabin where they can have access to an oxygen mask, thereby immobilizing them. Releasing sleeping gas (or other type of non-legal immobilizing gas) in the cabin and/or the passenger compartment will induce the hijackers to sleep. The sleeping gas countermeasure may also cause the passengers and/or crew to sleep, depending upon where in the aircraft 12 the gas is released.

Putting the cabin in total darkness limits the activities of the hijackers and makes communications between them more difficult because of the lack of visual contact between each other. In the event the hijackers bring along flashlights or other light sources, the inability to see the entire cabin also enables cabin crew and/or passengers to overpower them more easily.

The remote control module preferably provides the ground center 14 with the ability to control portions of the on-board computer 36, including the enhanced auto pilot module. This allows the ground center 14 to remotely redirect the aircraft 12 to a less populated region or to put it in holding circle or other predetermined flight pattern and prevent a hijacker from crashing the aircraft 12 deliberately.

The on-board computer 36 preferably comprises a programmable computer including a real-time operating system (RTOS) to manage, process and archive information from all of the on-board subsystems, including the sensor and surveillance subsystem 24 and cockpit and flight security subsystem 22. In particular, video encoding and compression is performed on the digital video data (light or infrared) in such a way that portions of the video archived can be retrieved quickly. The portion retrieved will have a resolution that is specifiable. It will also be possible to zoom into a particular part of each video image. The selectable resolution and zoom conserves the communication bandwidth needed between the aircraft and the ground monitoring and incident management center. Sensor-fusion can be performed on the light and infrared video data. Alternatively, the on-board computer 36 could comprise a dedicated digital system instead of a programmable computer.

The on-board computer 36 will process and compress the data to be transmitted to the ground monitoring and incident management center, package it into a data stream, perform encryption, and add error-correction coding, before handing the data stream to the transceiver 34.

The on-board computer 36 will authenticate and, if appropriate, process the commands from the ground monitoring and incident management center 14.

The data storage system will be designed to survive a crash, and will have redundancy to ensure the integrity of the data.

The on-board computer 36 preferably performs the following functions:

a. processing information from the surveillance and sensor subsystem 24;

b. archiving important aircraft information not already recorded by the CVR or the FDR, including data from all of the subsystems discussed above;

c. processing inputs from sensors such as panic buttons;

d. periodically updating the ground monitoring and incident management center 14; and

e. processing commands from the ground monitoring and incident management center 14.

The secure communication link 16 between the aircraft 12 and the ground center 14 preferably includes multiple redundancies to assure reliability of communications and to make sabotage difficult. The secure communication link 16 may include the following means of communication between the aircraft 12 and ground monitoring and incident management center 14:

a. satellite communications 16 via a satellite 18;

b. terrestrial means, e.g. a mobile phone-type system via a communications towers 20, when satellite communications is not available and/or during inland, low-altitude flight;

c. other radio-frequency transmissions, e.g. VHF or UHF; and

d. relaying of communications through other aircraft.

Most existing aircraft already have a satellite transceiver linked to the InmarSat Limited satellite communication system to provide phone services to passengers. One or more of the 9.6 kbps C-Channel of the InmarSat Areo-H service, providing a data transmission rate of at least 9.6 kbps, is the preferred primary means of communication. An alternative means of communication is preferably provided for times when satellite communication service is not available (e.g. when the aircraft 12 is on the ground or flying at low altitude). Such means could include, for example, a digital wireless communications system using the Global System for Mobile Communication (GSM) platform. An ad-hoc radio network, using VHF Digital Link (VDL) or another proprietary standard, could also be used as an alternative means of communication.

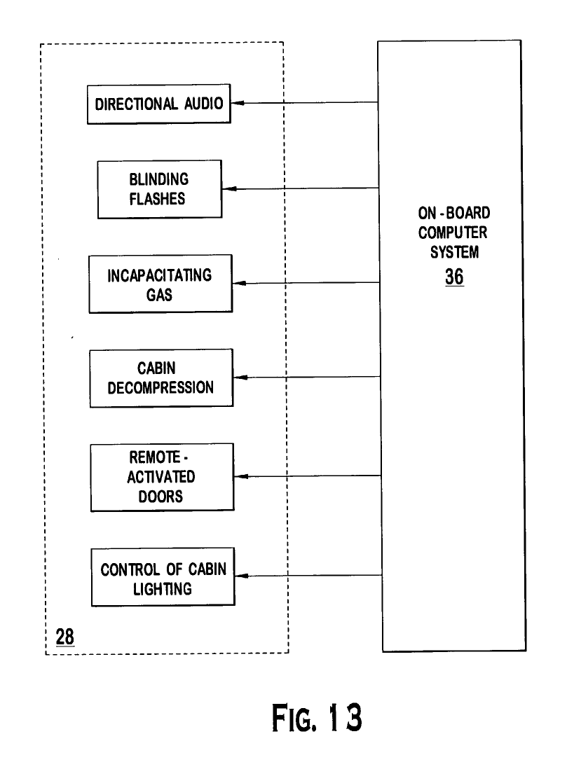

FIG. 13 illustrates the functional layout of a preferred embodiment of the on-board computer's 36 relationship to the countermeasures 28.

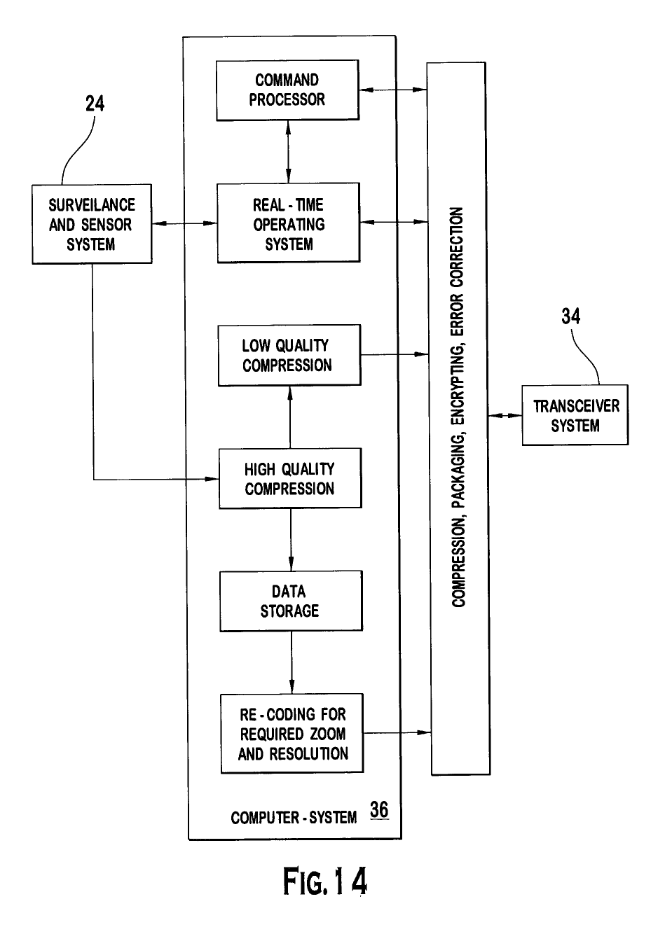

FIG. 14 illustrates the functional layout of a preferred embodiment of a portion of the on-board computer 36 used to process information from the surveillance and sensor system 24 and transmit such information through the transceiver system 34. Within the computer system, a real-time operating system 210 controls various software and hardware modules. A command processor 212 processes commands from the ground station 14 transmitted to the on-board computer system 36 via the transceiver subsystem 34. Video captured by video cameras in the surveillance and sensor system 24 system is compressed at high quality and stored in the data storage 214. A low quality (low frame rate, low resolution) video processed from the high quality video is sent down at regular intervals to the ground station 14 for monitoring, as needed. On demand from the ground station 14, video streams stored in the data storage 214 can be retrieved, re-coded for required zoom and resolution, and downloaded. Re-coding is necessary in order to minimize the bandwidth required. Between the on-board computer 36 and the transceiver system 34, a communication system 216 packages the different kinds of data (commands, video, audio, etc.) performs additional processing, such as compression, encryption and error correction, before the transceiver system 34 transmits it to the ground station 14 and vice-versa.

The ground monitoring and incident management center 14 preferably has the capability to monitor the following information transmitted from the aircraft 12:

a. location and altitude of aircraft 12;

b. signs of a possible threat and related information;

c. critical aircraft information, such as those recorded in the CVR and the FDR; and

d. digital video and audio.

In addition, during emergency situations, i.e., when the system 10 is in alert mode (discussed below), the ground monitoring and incident management center is able to perform the following functions by sending commands to the on-board computer 36:

a. retrieve selected information archived by the on-board computer on-demand;

b. retrieve real-time information from any part of the surveillance and sensor subsystem 24(including controlling their zoom, direction, etc), as well as any part of the cockpit instrument panel;

c. control individual passenger in-flight entertainment audio/video and cabin audio/video systems to communicate to passengers and/or crew individually or as a group; and

d. perform countermeasures 28.

To ensure that key decision-makers have quick access to the ground monitoring and incident management center in event of an emergency, the ground monitoring and incident management center should have a secure remote-access to the center through a wired or wireless network that allows information and commands to be passed between the key-decision maker(s), who is/are not physically located at the center, and the aircraft 12.

Secure remote access could be implemented with a number of existing means, including a Virtual Private Network (VPN) running over the Internet, dedicated lines (e.g., ISDN), mobile phone networks (e.g., GSM, GPRS, 3G, etc), or private mobile radio (PMR)/public-access mobile-radio (PAMR) systems (e.g., Tetra, Tetrapol, etc.). The remote access communications preferably are encrypted and require authentication.

In order to provide information to an investigation of an incident, the ground monitoring and incident management center 14 preferably has the capability to log all information received from the aircraft 12 and all communication (audio, video or computer commands) with the aircraft 12, during normal operation as well as in emergency situations.

The ground center 14 preferably has video screens, instrument panels, etc. to display all the information that is transmitted from the aircraft 12 to the ground center 14. It preferably has a terminal to command the on-board computer 36 on the aircraft 12 and audio/video means to communicate with passengers and crew on-board the aircraft 12 through the cabin or an passenger audio/video system.

Data-storage on the ground can be easily implemented with commercial off-the-shelf products.

Deployment of the system 10 in an area with a large number of aircraft, such as in the United States, will likely require multiple ground centers. In addition, each ground center preferably can monitor and communicate with multiple aircraft at once. In this case, the system 10 preferably includes an identification subsystem that enables the ground center 14 to positively identify and track each aircraft individually over the secure communication link 16.

The on-board system 21 is preferably designed so that there is no single point of failure. In particular, the system 21 will preferably have:

a. primary and secondary means of communications to the ground;

b. redundant sensors which include numerous dummy ones;

c. backup power supplies; and

d. a double ring structure that ensures redundant means of communications between aircraft subsystems.

The system 10 preferably has two modes: “normal mode” and “alert mode.” The normal mode is preferably much like the current level of communication between an aircraft and air traffic control, including periodic of the aircraft's 12 location. In normal mode, periodic image taken from cameras located in the cockpit and passenger cabin could be transmitted to the ground center 14.

In alert mode, the aircraft 12 is preferably in continuous communication with the ground station 14, exchanging data and commands. In addition, the alert mode preferably engages the aircraft sub-systems in the following ways:

a. the cockpit door, i.e., the front door of the double door module, is locked;

b. the auto pilot system is put into a locked mode that can only be unlocked by a command from the ground, by a password, or automatically unlocked at a predetermined point in the flight path, altitude, rate-of-descent or after a time-out from a timer.

c. the biometrics subsystem prevents entry of unauthorized persons into the cockpit.

d. circuit breakers for designated systems and subsystems, such as the aircraft transponder and autopilot, will be bypassed to prevent them from being disabled.

The alert mode is preferably activated by one or more of the following means:

a. activation of a panic button;

b. detection of tampering with any part of the system 21;

c. entry of an unauthorized person into the cockpit; and

d. suspicious activity on the aircraft 12 detected by a behavioral analyzer. Upon activation of alert mode, the ground center 14 is promptly informed. Preferably, the alert mode can only be deactivated by the ground station 14.

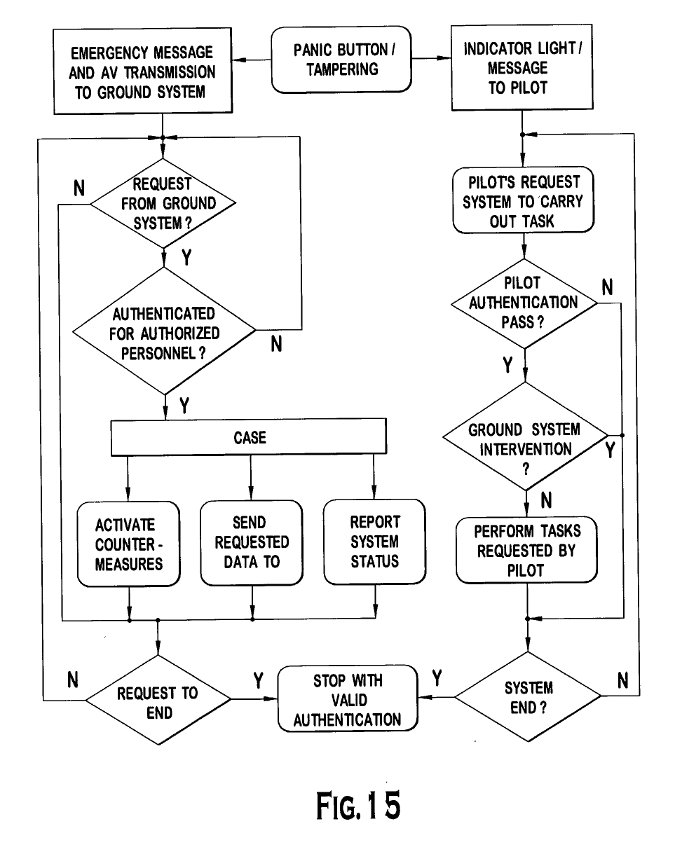

FIG. 15 is a flow chart showing the operational flow of the system 10 according to a preferred embodiment. When a panic button is activated, or when any part of the on-board system 21 is tampered with or when the double door module 44 has been breached by force, an emergency message as well as audio visual is transmitted to the ground station 14. At the same time, an indicator light 131 (see FIG. 12) alerts the pilot. The pilot can activate counter-measures on-board the aircraft after authentication. The pilot can also request the ground station 14 to take control of the aircraft 12. At the same time, with authentication, the ground station 14 can also activate the different subsystems on-board the aircraft 12, including counter-measures, audio visual data and other system information. Finally, both the ground-station and the pilot is able to request, with proper authentication, all operations to stop.

As the foregoing description demonstrates, the system 10 of the present invention provides robust protection against threats to the aircraft's 12 safety. The double door module 44 prevents unauthorized persons, such as a hijacker, from accessing the cockpit. Even if a person is able to circumvent the double door module 44, tamper sensors will activate the alert mode, which engages password protection for the auto pilot system. The double door module 44 may also provide time for the ground center 44 to react to the situation and take steps to protect the aircraft 12. The biometrics subsystem will prevent a hijacker or terrorist at the pilot seat 74 from controlling the aircraft 12. Countermeasures 28 can be used to attempt to force the unauthorized person to leave the pilot seat. The surveillance and security subsystem 24 and the cockpit and flight security subsystem 22 provide the crew and the ground center 14 with early warning of a potential threat to the aircraft 12. Once a threat has been identified, the ground center 14 has access to a wide range of information concerning the threat and is able to take action to neutralize the threat and otherwise preserve the safety of the aircraft 12.

The system 10 also provides the decision-makers with enhanced ability to communicate instructions to passengers, crew and even the persons posing the threat to the aircraft. Individual passengers and/or crew could be contacted remotely through a video phone system. Decision-makers could also have the ability to activate all or part of the countermeasure subsystem 28.

It is recognized by those skilled in the art, that changes may be made to the above-described embodiments of the invention without departing from the broad inventive concept thereof. It is understood, therefore, that this invention is not limited to the particular embodiments disclosed, but is intended to cover all modifications which are within the spirit and scope of the invention. For example, the invention could be beneficially implemented in other fixed or mobile environments, such as ships, trains, buses, cars, and the like.

What is claimed is:

1. A monitoring and incident management system for an aircraft having a cabin, including:
a plurality of sensors located on the aircraft that monitor critical aircraft information and activity on the aircraft;
at least one panic button located on the aircraft that can be activated by a person located in the cabin;
at least one computer located on the aircraft that receives and stores input from the plurality of sensors;
an incident management center located remotely from the aircraft;
a two-way communication link between the computer and the incident management center that is operationally configured to transmit multi-media data from the computer to the incident management center and to transmit commands from the incident management center to the computer.

2. The system of claim 1, wherein the plurality of sensors include at least one from the group of a digital video camera, an infrared video camera, a microphone, a door sensor, and a global positioning system.

3. The system of claim 1, wherein the two-way communication link is operationally configured to transmit the following information to the incident management center: location and altitude of the aircraft and input received by the computer from the plurality of sensors.

4. The system of claim 1, wherein the incident management center is operationally configured to perform the following functions through the two-way communication link: to retrieve information from the computer, to retrieve data from the plurality of sensors, to control the plurality of sensors, to communicate directly with individual passengers located on the aircraft.

5. The system of claim 4, wherein the incident management center is operationally configured to perform the following functions through the two-way communication link: decompressing the cabin, dumping fuel, and engaging an auto-pilot system.

6. The system of claim 1, wherein the two-way communication link comprises at least one from the group of a satellite link, a terrestrial communication link, and relaying of transmissions through other aircraft.

7. A security system for an aircraft cockpit comprising:
a cockpit door module having a frame, a front door and a rear door;
wherein said front door is operationally configured to open only when the rear door is closed.

8. The system of claim 7, wherein the aircraft further comprises a biometrics system that includes at least one identification device that identifies a person that interacts with the device as an authorized person or an unauthorized person and the front door only is operationally configured to unlock only when the biometrics system identifies the person that interacts with the identification device to be an authorized person or when a person located in the cockpit unlocks the front door.

9. The system of claim 8, wherein the at least one identification device comprises at least one from the group of: a facial recognition device, a fingerprint identification device, and a retinal scanner.

10. The system of claim 7, wherein the cockpit door module further includes at least one monitoring device.

11. The system of claim 10, wherein the monitoring device comprises at least one from the group of: a digital video camera, an infrared video camera, a microphone and a door sensor.

12. A monitoring and incident management system for an aircraft having a cabin, including:
an incident management center located remotely from the aircraft;
an on-board system including a computer in communication with a cockpit and flight security subsystem, a surveillance and sensor subsystem, and countermeasures; and
a two-way communication link between the computer and the incident management center that is operationally configured to transmit data from the computer to the incident management center and to transmit commands from the incident management center to the computer to control at least one of the flight security subsystem, the surveillance and sensor subsystem, and the countermeasures.

13. The system of claim 12, wherein the countermeasures comprise at least one from the group of directional audio, blinding flashes release of an incapacitating gas in the cabin, decompressing the cabin, selectively closing doors in the aircraft.

14. The system of claim 12, wherein the cockpit and flight security subsystem comprises a biometrics system that can determine whether a person interacting with the biometrics system is an authorized person or an unauthorized person.

15. The system of claim 12, wherein the cockpit and flight security subsystem comprises a cockpit door module having a frame and front and rear doors, the front door being operationally configured to unlock only when the rear door is closed.

16. The system of claim 14, wherein the cockpit and flight security subsystem comprises a cockpit door module having a frame and front and rear doors, the front door being operationally configured to unlock only when the biometrics system identifies the person that interacts with the identification device to be an authorized person or when a person located in the cockpit unlocks the front door.

17. The system of claim 12, wherein the cockpit and flight security subsystem comprises an autopilot system and the incident management center can transmit commands that control the autopilot system.

18. The system of claim 17, wherein the incident management center can command the autopilot system to cause the aircraft to fly in a predetermined flight pattern.

19. The system of claim 18, wherein the predetermined flight pattern comprises a holding circle.

20. The system of claim 19, wherein the system further comprises two operating modes, a normal mode and an alarm mode.

21. The system of claim 16, further comprising a switch located in the cockpit that can override the biometrics system to unlock the front door.
